(19) United States
(12) Patent Application Publication
(10) Pub. No.: US 2026/0228902 A1
(43) Pub. Date: Aug. 6, 2026

(54) SYSTEM AND METHOD FOR TRACKING KEYPOINTS OF AN OBJECT

(71) Applicant: Universal City Studios LLC, Universal City, CA (US)

(72) Inventor: Sarah La Forge, Titusville, FL (US)

(21) Appl. No.: 19/529,867

(22) Filed: Feb. 4, 2026

Related U.S. Application Data
(60) Provisional application No. 63/754,932, filed on Feb. 6, 2025.

(51) Int. Cl. G06T 7/246; G06T 5/80; G06T 7/80

(52) U.S. Cl. CPC G06T 7/248; G06T 5/80; G06T 7/80; G06T 2207/20084; G06T 2207/30196

(57) ABSTRACT

A tracking system for keypoints of an object includes a controller configured to iteratively perform a keypoint tracking process at a first frame rate. The keypoint tracking process includes receiving a ground-truth signal indicative of poses of the keypoints at a current ground-truth frame. The keypoint tracking process also includes determining the poses of the keypoints at the current ground-truth frame. In addition, the keypoint tracking process includes receiving a set of images of the object from an optical sensor at a second frame rate. Furthermore, the keypoint tracking process includes associating points within a first image of the set of images with the keypoints at a previous ground-truth frame via a calibration process. The keypoint tracking process also includes determining the poses of the keypoints of the object at each frame of one or more intermediate frames based on the set of images via an optical flow process.

### CROSS-REFERENCE TO RELATED APPLICATION

This application claims priority from and the benefit of U.S. Provisional Application Serial No. 63/754,932, entitled “SYSTEM AND METHOD FOR TRACKING KEYPOINTS OF AN OBJECT”, filed February 6, 2025, which is hereby incorporated by reference in its entirety.

### BACKGROUND

The present disclosure relates generally to a system and a method for tracking keypoints of an object.

Keypoints of an object may be tracked in three-dimensions to facilitate monitoring and/or controlling the object. Certain tracking systems include an optical sensor directed toward the object to monitor the keypoints, and a controller configured to determine the poses of the keypoints based on feedback from the optical sensor. For example, the controller may use a convolutional neural network to determine the poses of the keypoints. Furthermore, certain tracking systems include position sensors coupled to the object, and a controller configured to determine the poses of the keypoints based on feedback from the position sensors. For example, the controller may determine the poses of the keypoints of the object by interpreting the feedback from the position sensors, determining movement of the keypoints based on the interpretation, and updating the poses of the keypoints based on the movement. Unfortunately, such techniques for determining the poses of the keypoints may be significantly time-consuming, thereby resulting in a frame rate of the determined keypoint poses that is less than desired for monitoring and/or controlling the object.

### BRIEF DESCRIPTION

Certain embodiments commensurate in scope with the originally claimed subject matter are summarized below. These embodiments are not intended to limit the scope of the claimed subject matter, but rather these embodiments are intended only to provide a brief summary of possible forms of the claimed subject matter. Indeed, the claimed subject matter may encompass a variety of forms that may be similar to or different from the embodiments set forth below.

In certain embodiments, a tracking system for keypoints of an object includes a controller having a memory and a processor. The controller is configured to iteratively perform a keypoint tracking process at a first frame rate, and the keypoint tracking process includes receiving a ground-truth signal from a ground-truth sensor assembly indicative of poses of the keypoints of the object at a current ground-truth frame. The keypoint tracking process also includes determining the poses of the keypoints of the object at the current ground-truth frame. In addition, the keypoint tracking process includes receiving a set of images of the object from an optical sensor at a second frame rate, in which the second frame rate is greater than the first frame rate. Furthermore, the keypoint tracking process includes associating points within a first image of the set of images with the keypoints of the object at a previous ground-truth frame via a calibration process. The keypoint tracking process also includes determining the poses of the keypoints of the object at each frame of one or more intermediate frames based on the set of images via an optical flow process. In addition, the keypoint tracking process includes outputting, at the second frame rate, pose signals based on the poses of the keypoints of the object at multiple frames, in which the multiple frames include the previous ground-truth frame and the one or more intermediate frames.

Furthermore, in certain embodiments, a method for tracking keypoints of an object includes iteratively performing steps of the method at a first frame rate. The steps of the method include receiving, via a controller having a processor and a memory, a ground-truth signal from a ground-truth sensor assembly indicative of poses of the keypoints of the object at a current ground-truth frame, and determining, via the controller, the poses of the keypoints of the object at the current ground-truth frame. The steps of the method also include receiving, via the controller, a set of images of the object from an optical sensor at a second frame rate, in which the second frame rate is greater than the first frame rate. Furthermore, the steps of the method include associating, via the controller, points within a first image of the set of images with the keypoints of the object at a previous ground-truth frame via a calibration process. In addition, the steps of the method include determining, via the controller, the poses of the keypoints of the object at each frame of one or more intermediate frames based on the set of images via an optical flow process. The steps of the method also include outputting, via the controller at the second frame rate, pose signals based on the poses of the keypoints of the object at multiple frames, in which the multiple frames include the previous ground-truth frame and the one or more intermediate frames.

In addition, in certain embodiments, a tracking system for keypoints of an object includes a ground-truth sensor assembly configured to output a ground-truth signal indicative of poses of the keypoints of the object, and an optical sensor configured to output images of the object. The tracking system also includes a controller communicatively coupled to the ground-truth sensor assembly and to the optical sensor. The controller includes a memory and a processor, and the controller is configured to iteratively perform a keypoint tracking process at a first frame rate. The keypoint tracking process includes receiving the ground-truth signal from the ground-truth sensor assembly indicative of the poses of the keypoints of the object at a current ground-truth frame, and determining the poses of the keypoints of the object at the current ground-truth frame. The keypoint tracking process also includes receiving a set of the images of the object from the optical sensor at a second frame rate, in which the second frame rate is greater than the first frame rate. In addition, the keypoint tracking process includes associating points within a first image of the set of images with the keypoints of the object at a previous ground-truth frame via a calibration process, and determining the poses of the keypoints of the object at each frame of one or more intermediate frames based on the set of images via an optical flow process. Furthermore, the keypoint tracking process includes outputting, at the second frame rate, pose signals based on the poses of the keypoints of the object at multiple frames, in which the multiple frames include the previous ground-truth frame and the one or more intermediate frames.

### BRIEF DESCRIPTION OF THE DRAWINGS

These and other features, aspects, and advantages of the present disclosure will become better understood when the following detailed description is read with reference to the accompanying drawings in which like characters represent like parts throughout the drawings, wherein:

FIG. 1 is a perspective view of an embodiment of an interactive environment;

FIG. 2 is a block diagram of an embodiment of a tracking system for keypoints of an object that may be employed within the interactive environment of FIG. 1;

FIG. 3 is an embodiment of an image of a portion of an object that may be disposed within the interactive environment of FIG. 1;

FIG. 4 is a chart of an embodiment of a method for tracking keypoints of an object within an interactive environment;

FIG. 5 is a flow diagram of an embodiment of a method for tracking keypoints of an object within an interactive environment;

FIG. 6 is a flow diagram of an embodiment of an optical flow process, which may be employed within the method of FIG. 5; and

FIG. 7 is a flow diagram of an embodiment of a calibration process, which may be employed within the method of FIG. 5.

### DETAILED DESCRIPTION

One or more specific embodiments of the present disclosure will be described below. To provide a concise description of these embodiments, all features of an actual implementation may not be described in the specification. It should be appreciated that in the development of any such actual implementation, as in any engineering or design project, numerous implementation-specific decisions must be made to achieve the developers’ specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” “the,” and “said” are intended to mean that there are one or more of the elements. The terms “comprising,” “including,” and “having” are intended to be inclusive and mean that there may be additional elements other than the listed elements. Any examples of operating parameters and/or environmental conditions are not exclusive of other parameters/conditions of the disclosed embodiments.

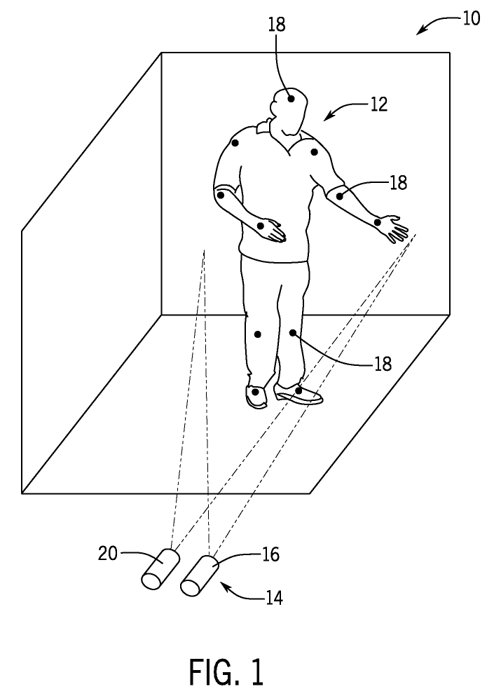

FIG. 1 is a perspective view of an embodiment of an interactive environment 10. As illustrated, an object 12 is disposed within the interactive environment 10. In the illustrated embodiment, the object 12 is an animated figure. However, in other embodiments, other suitable object(s) may be disposed within the interactive environment (e.g., alone or in combination with the animated figure), such as vehicle(s), equipment, etc. The object 12 is configured to move within the interactive environment 10, and the object 12 includes articulated components (e.g., limbs, etc.) configured to move relative to one another.

In the illustrated embodiment, the interactive environment includes a tracking system 14 configured to monitor movement of the object 12 and the articulated components of the object 12 within the interactive environment 10. The tracking system 14 includes a ground-truth sensor assembly 16 configured to output ground-truth signal(s) indicative of poses of keypoints 18 of the object 12. The keypoints 18 correspond to portions of the object 12 that are tracked by the tracking system 14. The keypoints 18 may be marked (e.g., with visual identifiers) to facilitate detection of the keypoints 18, or the keypoints 18 may be unmarked (e.g., the keypoints may correspond to joints of the object 12, etc.). In certain embodiments, the ground-truth sensor assembly 16 includes an optical sensor, and the ground-truth signal(s) are indicative of ground-truth image(s) of the object 12. Furthermore, in certain embodiments, the ground truth sensor assembly 16 includes position sensors coupled to the object 12. In addition, the tracking system 14 includes an optical sensor 20 configured to output a set of images of the object 12. The optical sensor 20 may include any suitable type(s) of optical sensing device(s), such as camera(s), infrared sensor(s), etc. As used herein with regard to the keypoints 18, “pose” refers to a position and/or an orientation of the keypoint 18 within the interactive environment 10.

As discussed in detail below, the tracking system 14 also includes a controller communicatively coupled to the ground-truth sensor assembly 16 and to the optical sensor 20. The controller includes a memory and a processor, and the controller is configured to iteratively perform a keypoint tracking process at a first frame rate. The keypoint tracking process includes receiving the ground-truth signal(s) from the ground-truth sensor assembly 16 indicative of the poses of the keypoints 18 of the object 12 at a current ground-truth frame. The keypoint tracking process also includes determining the poses of the keypoints 18 of the object 12 at the current ground-truth frame. Furthermore, the keypoint tracking process includes receiving a set of images from the optical sensor 20 at a second frame rate, which is greater than the first frame rate. In addition, the keypoint tracking process includes associating points within a first image of the set of images with the keypoints of the object at a previous ground-truth frame via a calibration process. The keypoint tracking process also includes determining the poses of the keypoints 18 of the object 12 at each frame of one or more intermediate frames based on the set of images via an optical flow process. Furthermore, the keypoint tracking process includes outputting, at the second frame rate, pose signals based on the poses of the keypoints 18 of the object 12 at multiple frames, in which the multiple frames include the previous ground-truth frame and the one or more intermediate frames.

As previously discussed, in certain embodiments, the ground-truth sensor assembly 16 includes an optical sensor, and the ground-truth signal(s) are indicative of ground-truth image(s) of the object 12. In such embodiments, the controller may determine the poses of the keypoints 18 of the object 12 at the current ground-truth frame using a convolutional neural network (CNN). Furthermore, in certain embodiments, the ground-truth sensor assembly 16 includes position sensors coupled to the object 12. In such embodiments, the controller is configured to determine the poses of the keypoints 18 of the object 12 at the current ground-truth frame by interpreting the feedback from the position sensors, determining movement of the keypoints 18 based on the interpretation, and updating the poses of the keypoints 18 based on the movement. The first frame rate may be set such that the inverse of the first frame rate is equal to the duration sufficient for the controller to determine the poses of the keypoints 18 of the object 12 at the current ground-truth frame (e.g., based on feedback from the ground-truth optical sensor or based on feedback from the position sensors). Accordingly, the duration between ground-truth frames may be equal to the inverse of the first frame rate. For example, if the duration sufficient for the controller to determine the poses of the keypoints 18 of the object 12 at the current ground-truth frame is 0.1 seconds, the first frame rate may be set to 10 Hz. As used herein, “frame” refers to a point in time at which the poses of the keypoints are determined (e.g., the determination of the poses of the keypoints is complete).

To increase the rate at which the poses of the keypoints 18 of the object 12 are determined, the controller determines the poses of the keypoints 18 of the object 12 at each frame of the one or more intermediate frames based on the set of images from the optical sensor 20 via the optical flow process. The duration sufficient for the controller to determine the poses of the keypoints 18 of the object 12 using the optical flow process may be significantly shorter than the duration sufficient for the controller to determine the poses of the keypoints 18 of the object 12 using the techniques disclosed above for determining the keypoints at each ground-truth frame. The second frame rate may be set such that the inverse of the second frame rate is equal to the duration sufficient for the controller to determine the poses of the keypoints 18 of the object 12 using the optical flow process. As previously discussed, the set of images are received by the controller at the second frame rate, which is greater than the first frame rate. For example, the first frame rate may be 10 Hz, and the second frame rate may be 100 Hz. Accordingly, nine intermediate frames may be located between adjacent ground-truth frames. As used herein, “intermediate frame” refers to a frame between adjacent ground-truth frames (e.g., between the previous ground-truth frame and the current ground truth frame). Using the combination of determining the keypoints of the object at the ground-truth frames and determining the keypoints of the object between ground-truth frames using the optical flow process, the rate at which the poses of the keypoints 18 of the object 12 are determine may be increased (e.g., as compared to determining the poses of the keypoints of the object at the ground-truth frames alone). In addition, the accuracy of the poses of the keypoints of the object may be increased (e.g., as compared to using the optical flow process alone).

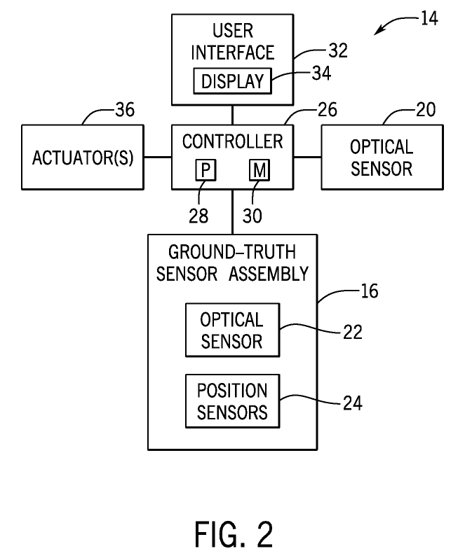

FIG. 2 is a block diagram of an embodiment of a tracking system 14 for keypoints of an object that may be employed within the interactive environment of FIG. 1. As previously discussed, the tracking system 14 includes the ground-truth sensor assembly 16, which is configured to output ground-truth signal(s) indicative of poses of the keypoints of the object within the interactive environment. In certain embodiments, the ground-truth sensor assembly 16 includes an optical sensor 22 (e.g., second optical sensor), and the ground-truth signal(s) are indicative of ground-truth image(s) of the object 12. The optical sensor 22 may include any suitable type(s) of optical sensing device(s), such as camera(s), infrared sensor(s), etc. For example, the optical sensor may include multiple optical sensing devices configured to monitor different regions of the interactive environment. Furthermore, in certain embodiments, the optical sensor may include actuator(s) configured to move the optical sensing device(s) (e.g., based on movement of the object). In addition, in certain embodiments, the ground-truth sensor assembly 16 includes position sensors 24 coupled to the object. Each position sensor may include any suitable type(s) of position and/or orientation sensing device(s), such as gyroscopic sensor(s), accelerometer(s), inertial measurement unit(s), other suitable type(s) of sensor(s), or a combination thereof. While the ground-truth sensor assembly 16 includes the optical sensor 22 and the position sensors 24 in the illustrated embodiment, in other embodiments, the ground-truth sensor assembly may include only one of the optical sensor or the positions sensors.

As previously discussed, the tracking system 14 includes the optical sensor 20, which is configured to output images of the object. The optical sensor 20 may include any suitable type(s) of optical sensing device(s), such as camera(s), infrared sensor(s), etc. For example, the optical sensor may include multiple optical sensing devices configured to monitor different regions of the interactive environment. Furthermore, in certain embodiments, optical sensor may include actuator(s) configured to move the optical sensing device(s) (e.g., based on movement of the object). In the illustrated embodiment, the optical sensor 20 is separate from the ground-truth optical sensor 22. However, in other embodiments, a single optical sensor may function as the optical sensor 20 and the ground-truth optical sensor 22.

In the illustrated embodiment, the tracking system 14 includes a controller 26 communicatively coupled to the ground-truth sensor assembly 16 (e.g., the optical sensor 22 and/or the position sensors 24 of the ground-truth sensor assembly 16) and to the optical sensor 20. In certain embodiments, the controller 26 is an electronic controller having electrical circuitry configured to receive the ground-truth signal(s) from the ground-truth sensor assembly 16 and images (e.g., signals indicative of the images) from the optical sensor 20. In the illustrated embodiment, the controller 26 includes a processor 28, such as a microprocessor. The controller 26 may also include one or more storage devices such as the illustrated memory device 30 and/or other suitable components. The processor 28 may be used to execute software, such as software for tracking keypoints of the object, and so forth. Moreover, the processor 28 may include multiple microprocessors, one or more “general-purpose” microprocessors, one or more special-purpose microprocessors, one or more application specific integrated circuits (ASICs), one or more reduced instruction set (RISC) processors, or some combination thereof.

The memory device 30 may include a volatile memory such as random access memory (RAM), and/or a nonvolatile memory such as read-only memory (ROM). The memory device 30 may store a variety of information and may be used for various purposes. For example, the memory device 30 may store processor-executable instructions (e.g., firmware or software) for the processor 28 to execute, such as instructions for tracking keypoints of the object, and so forth. The storage device(s) (e.g., nonvolatile storage) may include ROM, flash memory, a hard drive, or any other suitable optical, magnetic, or solid-state storage medium, or a combination thereof. The storage device(s) may store data, instructions (e.g., software or firmware for tracking keypoints of the object, etc.), and any other suitable data.

In the illustrated embodiment, the tracking system 14 includes a user interface 32 communicatively coupled to the controller 26. The user interface 32 is configured to receive input from an operator and to provide information to the operator. The user interface 32 may include any suitable input device(s) for receiving input, such as a keyboard, a mouse, button(s), switch(es), knob(s), other suitable input device(s), or a combination thereof. In addition, the user interface 32 may include any suitable output device(s) for presenting information to the operator, such as speaker(s), indicator light(s), other suitable output device(s), or a combination thereof. In the illustrated embodiment, the user interface 32 includes a display 34 configured to present visual information to the operator. In certain embodiments, the display 34 may include a touchscreen interface configured to receive input from the operator.

The controller 26 is configured to iteratively perform the keypoint tracking process at the first frame rate. As previously discussed, the keypoint tracking process includes receiving the ground-truth signal(s) from the ground-truth sensor assembly 16 indicative of the poses of the keypoints of the object at a current ground-truth frame. In addition, the keypoint tracking process includes determining the poses of the keypoints of the object at the current ground-truth frame. As previously discussed, the duration sufficient for the controller to determine the poses of the keypoints of the object at the current ground-truth frame may be equal to the inverse of the first frame rate. In embodiments in which the ground-truth sensor assembly 16 includes the optical sensor 22 (e.g., second optical sensor), the ground-truth signal(s) are indicative of ground-truth image(s) of the object. In certain embodiments, the controller determines the poses of the keypoints of the object at the current ground-truth frame based on a respective ground-truth image using a convolutional neural network. However, in other embodiments, the controller may determine the poses of the keypoints of the object at the current ground-truth frame based on the respective ground-truth image using another suitable type of computer vision analysis process. Furthermore, in embodiments in which the ground-truth sensor 16 includes the position sensors 24, the ground-truth signal(s) are indicative of positions and/or orientations of the keypoints of the object. In certain embodiments, the controller determines the poses of the keypoints of the object at the current ground-truth frame by interpreting the feedback from the position sensors 24, determining movement of the keypoints based on the interpretation, and updating the poses of the keypoints (e.g., from poses of the keypoints determined at the previous ground-truth frame) based on the movement. However, in other embodiments, the controller may use another suitable process for determining the poses of the keypoints of the object based on the feedback from the positions sensors.

Furthermore, the keypoint tracking process includes receiving a set of images of the object from the optical sensor 20 at the second frame rate, which is greater than the first frame rate. The keypoint tracking process also includes associating points within a first image of the set of images with the keypoints of the object at a previous ground-truth frame via the calibration process. In embodiments in which the ground-truth sensor assembly 16 includes the optical sensor 22 (e.g., second optical sensor), the calibration process may include optically matching the points within the first image with the keypoints of the object at the previous ground-truth frame. The controller may perform the optical matching using any suitable technique. For example, if the optical sensor 22 of the ground-truth sensor assembly 16 is positioned adjacent to the optical sensor 20, the calibration process may include optically matching each point with the nearest keypoint. In addition, if the optical sensor 22 of the ground-truth sensor assembly 16 is offset from the optical sensor 20, the points may be shifted to account for the offset, thereby enabling each point to be optically matched with the nearest keypoint. Furthermore, in embodiments in which the ground-truth sensor assembly 16 includes the position sensors 24, the calibration process may include determining two-dimensional positions of the keypoints of the object at the previous ground-truth frame from a perspective of the optical sensor (e.g., using a suitable computer vision technique) and matching each point within the first image with the nearest keypoint based on the two-dimensional position of the keypoint.

Furthermore, the keypoint tracking process includes determining poses of the keypoints of the object at each frame of the one or more intermediate frames based on the set of images via an optical flow process. As previously discussed, the duration sufficient for the controller to determine the poses of the keypoints of the object using the optical flow process may be equal to the inverse of the second frame rate. In addition, the keypoint tracking process includes outputting, at the second frame rate, pose signals based on the poses of the keypoints of the object at multiple frames, in which the multiple frames include the previous ground-truth frame and the one or more intermediate frames. Using the combination of determining the keypoints of the object at the ground-truth frames and determining the keypoints of the object between ground-truth frames using the optical flow process, the rate at which the poses of the keypoints of the object are determine may be increased (e.g., as compared to determining the poses of the keypoints of the object at the ground-truth frames alone). In addition, the accuracy of the poses of the keypoints of the object may be increased (e.g., as compared to using the optical flow process alone).

The optical flow process may include tracking movement of each point between images of the set of images and determining a change in pose of a respective keypoint associated with the point based on the movement of the point. As discussed in detail below, in certain embodiments, the optical flow process includes establishing a pixel patch around each point, in which each point is associated with a respective keypoint of the object. In addition, the optical flow process includes tracking movement of the point between images within the pixel patch and determining the pose of the respective keypoint based on the movement of the point. Tracking movement of the points within the pixel patches may be less computationally intensive and utilize less memory capacity than tracking movement of the points within the entirety of the set of images.

In certain embodiments, the pose signals are indicative of the poses of the keypoints, and the pose signals are output to the user interface 32. For example, the controller 26 may output the pose signals to the user interface 32, and the display 34 of the user interface 32 may present an image of the object based on the poses of the keypoints of the object. Accordingly, an operator may monitor the poses of the keypoints by viewing the display 34. Furthermore, in certain embodiments, the tracking system 14 includes one or more actuators 36 communicatively coupled to the controller 26. The actuator(s) 36 are coupled to the object and configured to control movement of the keypoints of the object. In certain embodiments, the pose signals are indicative of control inputs to the actuator(s) 36 based on the poses of the keypoints of the object. For example, the controller 26 may determine control inputs for the actuator(s) 36 based on the poses of the keypoints of the object and, in certain embodiments, input from the user interface 32, a stored movement plan, other suitable information, or a combination thereof. The controller 26 may then output the pose signals indicative of the control inputs to the actuator(s) 36, thereby controlling the object based on the poses of the keypoints of the object.

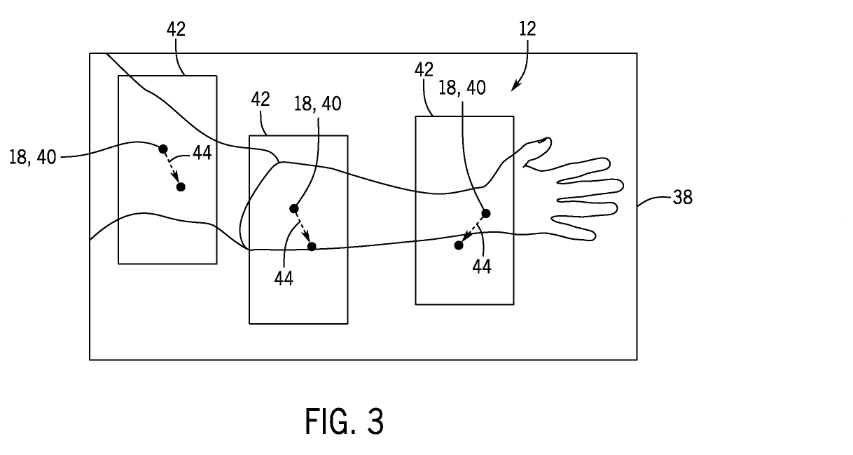

FIG. 3 is an embodiment of an image 38 of a portion of an object 12 that may be disposed within the interactive environment of FIG. 1. In the illustrated embodiment, the portion of the object 12 includes three keypoints 18. As previously discussed, the controller of the tracking system is configured to iteratively perform the keypoint tracking process at the first frame rate. The keypoint tracking process includes receiving a set of images of the object 12 from the optical sensor at the second frame rate, associating points 40 within a first image of the set of images with the keypoints 18 of the object 12 at a previous ground-truth frame via the calibration process, and determining poses of the keypoints 18 of the object 12 at each frame of one or more intermediate frames based on the set of images via the optical flow process.

In the illustrated embodiment, the optical flow process includes establishing a pixel patch 42 around each point 40, in which each point 40 is associated with a respective keypoint 18 of the object 12. The pixel patches 42 may be positioned around each point 40 within each image of the set of images, and the pixel patches 42 may remain fixed within the images (e.g., fixed relative to the bounds of the images). Furthermore, the optical flow process includes tracking movement of each point 40 between images of the set of images within the respective pixel patch 42. For example, the dashed lines 44 represent movement of the points 40 between the image 38 and a subsequent image. Furthermore, the optical flow process includes determining the pose of the respective keypoint 18 based on the movement of each point 40. Tracking movement of the points within the pixel patches may be less computationally intensive and utilize less memory capacity than tracking movement of the points within the entirety of the set of images.

In certain embodiments, each pixel patch 42 may be positioned such that the respective point 40 is positioned at a center of the pixel patch 42 (e.g., lateral center and vertical center of the pixel patch) in the first image of the set of images. The size and shape of each pixel patch 42 may be selected based on an expected movement of the respective point and the distance of the respective point from the optical sensor. For example, if less movement is expected, the pixel patch may be smaller, and if more movement is expected, the pixel patch may be larger. In addition, if the point is farther from the optical sensor, the pixel patch may be smaller, and if the point is closer to the optical sensor, the pixel patch may be larger. In certain embodiments, the size of each pixel patch may be determined for each respective point. However, in other embodiments, the pixel patches may be the same size. In such embodiments, the size of the pixel patches may be equal to the size of the largest determined pixel patch. Furthermore, the pixel patches may have any suitable shape (e.g., rectangular, square, circular, etc.).

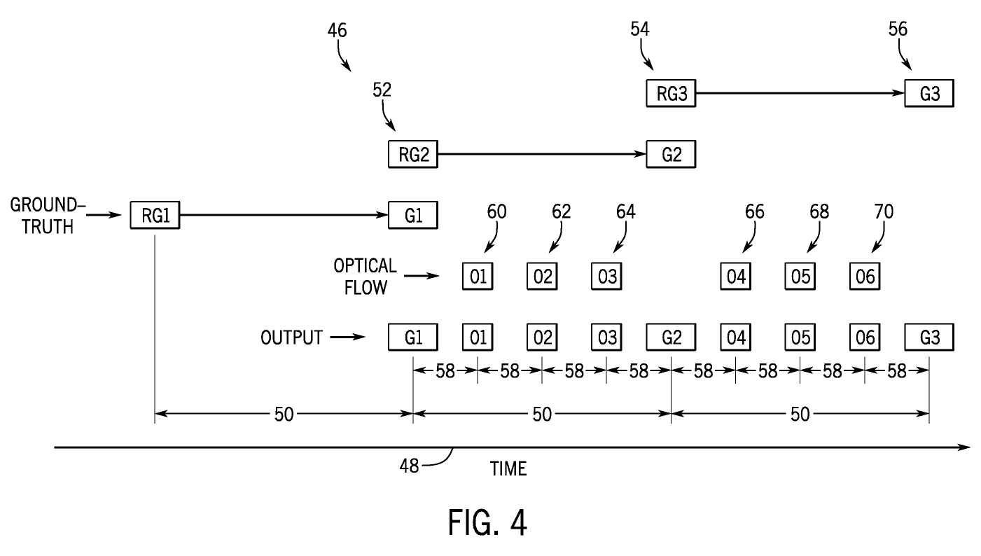

FIG. 4 is a chart 46 of an embodiment of a method for tracking keypoints of an object within an interactive environment. The chart 46 includes a time axis 48 that increases to the right. As previously discussed, the controller is configured to iteratively perform the keypoint tracking process at the first frame rate. The keypoint tracking process includes receiving the ground-truth signal(s) from the ground-truth sensor assembly indicative of the poses of the keypoints of the object at a current ground-truth frame. The keypoint tracking process also includes determining the poses of the keypoints of the object at the current ground-truth frame. As previously discussed, the first frame rate may be set such that the inverse of the first frame rate is equal to the duration 50 sufficient for the controller to determine the poses of the keypoints of the object at the current ground-truth frame (e.g., based on feedback from the optical sensor or based on feedback from the position sensors). Accordingly, the duration 50 between ground-truth frames may be equal to the inverse of the first frame rate. For example, if the duration 50 sufficient for the controller to determine the poses of the keypoints of the object at the current ground-truth frame is 0.1 seconds, the first frame rate may be set to 10 Hz.

As illustrated, RG1 represents receiving a first ground-truth signal indicative of poses of the keypoints of the object at a first ground-truth frame 52. In addition, G1 represents the determined poses of the keypoints of the object at the first ground-truth frame 52. As illustrated, RG1 and G1 are separated by the duration 50 sufficient for the controller to determine the poses of the keypoints of the object. In addition, RG2 represents receiving a second ground-truth signal indicative of poses of the keypoints of the object at a second ground-truth frame 54. As illustrated, the second ground-truth signal is received at the same time the keypoints of the object at the first ground-truth frame 52 are determined. In addition, G2 represents the determined poses of the keypoints of the object at the second ground-truth frame 54. As illustrated, RG2 and G2 are separated by the duration 50 sufficient for the controller to determine the poses of the keypoints of the object. Furthermore, RG3 represents receiving a third ground-truth signal indicative of poses of the keypoints of the object at a third ground-truth frame 56. As illustrated, the third ground-truth signal is received at the same time the keypoints of the object at the second ground-truth frame 54 are determined. In addition, G3 represents the determined poses of the keypoints of the object at the third ground-truth frame 56. As illustrated, RG3 and G3 are separated by the duration 50 sufficient for the controller to determine the poses of the keypoints of the object.

Furthermore, the keypoint tracking process includes receiving a set of the images from the optical sensor at the second frame rate, which is greater than the first frame rate. In addition, the keypoint tracking process includes associating points within a first image of the set of images with the keypoints of the object at a previous ground-truth frame via a calibration process. The keypoint tracking process also includes determining the poses of the keypoints of the object at each frame of one or more intermediate frames based on the set of images via the optical flow process. The duration 58 sufficient for the controller to determine the poses of the keypoints of the object using the optical flow process may be significantly shorter than the duration 50 sufficient for the controller to determine the poses of the keypoints of the object using the techniques disclosed above for determining the keypoints at the ground-truth frames. The second frame rate may be set such that the inverse of the second frame rate is equal to the duration 58 sufficient for the controller to determine the poses of the keypoints of the object using the optical flow process. As previously discussed, the set of images are received by the controller at the second frame rate, which is greater than the first frame rate. For example, if the first frame rate is 10 Hz, the second frame rate may be 100 Hz.

As illustrated, O1 represents the determined poses of the keypoints of the object at a first intermediate frame 60, O2 represents the determined poses of the keypoints of the object at a second intermediate frame 62, and O3 represents the determined poses of the keypoints of the object at a third intermediate frame 64. As illustrated, O1 is separated from G1 by the duration 58 sufficient for the controller to determine the poses of the keypoints of the object using the optical flow process, and O3 is separated from G2 by the duration 58. Furthermore, O4 represents the determined poses of the keypoints of the object at a fourth intermediate frame 66 (e.g., first intermediate frame after the second ground-truth frame 54), O5 represents the determined poses of the keypoints of the object at a fifth intermediate frame 68 (e.g., second intermediate frame after the second ground-truth frame 54), and O6 represents the determined poses of the keypoints of the object at a sixth intermediate frame 70 (e.g., third intermediate frame after the second ground-truth frame 54). As illustrated, O4 is separated from G2 by the duration 58 sufficient for the controller to determine the poses of the keypoints of the object using the optical flow process, and O6 is separated from G3 by the duration 58.

In the illustrated embodiment, O1, O2, and O3 are determined based on a first set of images via the optical flow process, and O4, O5, and O6 are determined based on a second set of images via the optical flow process. The calibration process is performed before the first intermediate frame 60 to associate points within the first image of the first set of images with the keypoints of the object at the first ground-truth frame 52 (e.g., the previous ground-truth frame). In addition, the calibration process is performed before the fourth intermediate frame 66 to associate points within the first image of the second set of images with the keypoints of the object at the second ground-truth frame 54 (e.g., the previous ground truth frame).

Furthermore, the keypoint tracking process includes outputting, at the second frame rate, pose signals based on the poses of the keypoints of the object at multiple frames, in which the multiple frames include the previous ground-truth frame and the one or more intermediate frames. Accordingly, a pose signal based on G1 is output at the first ground-truth frame 52, pose signals based on O1, O2, and O3 are output at the subsequent intermediate frames, a pose signal based on G2 is output at the second ground-truth frame 54, pose signals based on O4, O5, and O6 are output at the subsequent intermediate frames, and a pose signal based on G3 is output at the third ground-truth frame. Using the combination of determining the keypoints of the object at the ground-truth frames and determining the keypoints of the object between ground-truth frames using the optical flow process, the rate at which the poses of the keypoints of the object are determine may be increased (e.g., as compared to determining the poses of the keypoints of the object at the ground-truth frames alone). In addition, the accuracy of the poses of the keypoints of the object may be increased (e.g., as compared to using the optical flow process alone).

Because the points within the first image of each set of images are associated with the keypoints of the object at the previous ground-truth frame via the calibration process, and the poses of the keypoints of the object at each frame of the one or more intermediate frames are determined based on the set of images via the optical flow process, a discontinuity may be present between the poses of the keypoints of the object at the previous ground-truth frame and the poses of the keypoints of the object at the first intermediate frame. However, when higher frame rates are used (e.g., a 10 Hz ground-truth frame rate), the discontinuity may be insignificant (e.g., not noticeable by an observer and/or having a trivial effect on actuator control). Furthermore, when lower frame rates are used (e.g., a 5 Hz ground-truth frame rate, a 1 Hz ground-truth frame rate, etc.), the discontinuity may be moderated (e.g., significantly diminished) using a filtering or smoothing technique, such as Kalman filtering, which may be based on predicted movement of the keypoints. Additionally or alternatively, the discontinuity may be moderated using the physical properties of the object, such as by applying constraints on the movement of the keypoints (e.g., restricting optical flow) based on the physical properties of the object.

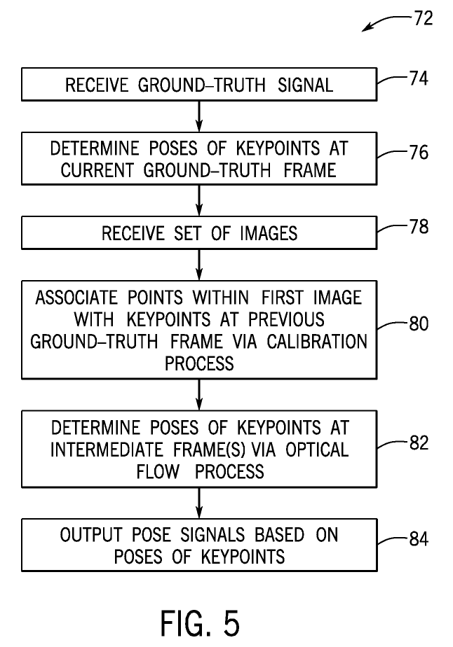

FIG. 5 is a flow diagram of an embodiment of a method 72 for tracking keypoints of an object within an interactive environment. The method 72 may be performed by the controller disclosed above with reference to FIG. 2, by one or more other suitable controllers, or a combination thereof. Furthermore, the steps of the method 72 may be performed in the order disclosed below or in any other suitable order. In addition, in certain embodiments, one or more steps of the method 72 may be omitted, and/or the method may include one or more additional steps.

The steps of the method 72 may be performed iteratively at a first frame rate. The method 72 includes receiving a ground-truth signal from a ground-truth sensor assembly indicative of poses of the keypoints of the object at a current ground-truth frame, as represented by block 74. As previously discussed, the ground-truth sensor assembly may include an optical sensor (e.g., second optical sensor). Furthermore, the ground-truth sensor assembly may include positions sensors coupled to the object. The method 72 also includes determining the poses of the keypoints of the object at the current ground-truth frame, as represented by block 76. In embodiments in which the ground-truth sensor assembly includes an optical sensor, the poses of the keypoints of the object at the current ground-truth frame may be determined using a convolutional neural network (CNN). In addition, in embodiments in which the ground-truth sensor assembly includes positions sensors, the poses of the keypoints of the object at the current ground-truth frame may be determined by interpreting feedback from the position sensors, determining movement of the keypoints based on the interpretation, and updating the poses of the keypoints based on the movement.

Furthermore, the method 72 includes receiving a set of images of the object from an optical sensor at a second frame rate, as represented by block 78. The method 72 also includes associating points within a first image of the set of images with the keypoints of the object at a previous ground-truth frame via a calibration process, as represented by block 80. In embodiments in which the ground-truth sensor assembly includes the optical sensor (e.g., second optical sensor), the calibration process may include optically matching the points within the first image with the keypoints of the object at the previous ground-truth frame. In embodiments in which the ground-truth sensor assembly includes the positions sensors, the calibration process may include determining two-dimensional positions of the keypoints of the object at the previous ground-truth frame from a perspective of the optical sensor and matching the points within the first image with the two-dimensional positions, as disclosed below with reference to FIG. 7.

In addition, the method 72 includes determining the poses of the keypoints of the object at each frame of one or more intermediate frames based on the set of images via an optical flow process, as represented by block 82. As previously discussed, the optical flow process may include tracking movement of each point between images of the set of images and determining a change in pose of a respective keypoint associated with the point based on the movement of the point. The method 72 also includes outputting, at the second frame rate, pose signals based on the poses of the keypoints of the object at multiple frames, in which the multiple frames include the previous ground-truth frame and the one or more intermediate frames, as represented by block 84. In certain embodiments, the pose signals are indicative of the poses of the keypoints, and the pose signals are output to a user interface, thereby enabling the user interface to present an image of the object based on the poses of the keypoints of the object. Furthermore, in certain embodiments, the pose signals are indicative of control inputs to actuator(s) based on the poses of the keypoints of the object, and the pose signals are output to the actuator(s) to control movement of the object.

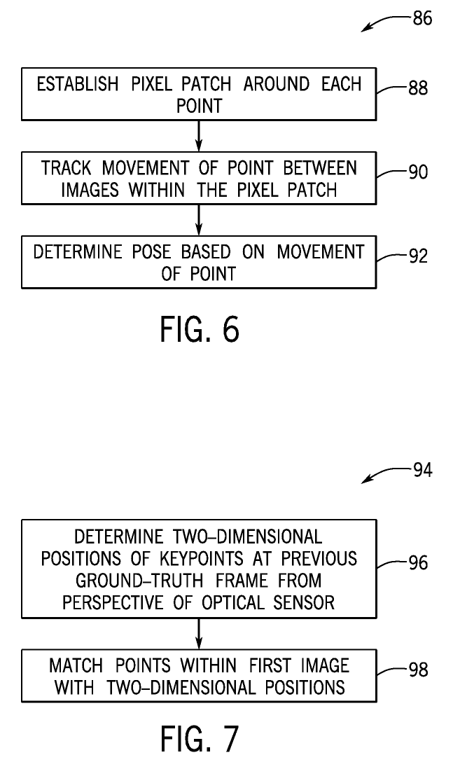

FIG. 6 is a flow diagram of an embodiment of an optical flow process 86, which may be employed within the method of FIG. 5. The process 86 may be performed by the controller disclosed above with reference to FIG. 2, by one or more other suitable controllers, or a combination thereof. Furthermore, the steps of the process 86 may be performed in the order disclosed below or in any other suitable order. In addition, in certain embodiments, one or more steps of the process 86 may be omitted, and/or the process may include one or more additional steps.

The process 86 includes establishing a pixel patch around each point, in which each point is associated with a respective keypoint of the object, as represented by block 88. In addition, the process 86 includes tracking movement of the point between images within the pixel patch, as represented by block 90, and determining the pose of the respective keypoint based on the movement of the point, as represented by block 92. Tracking movement of the points within the pixel patches may be less computationally intensive and utilize less memory capacity than tracking movement of the points within the entirety of the set of images.

FIG. 7 is a flow diagram of an embodiment of a calibration process 94, which may be employed within the method of FIG. 5. The process 94 may be performed by the controller disclosed above with reference to FIG. 2, by one or more other suitable controllers, or a combination thereof. Furthermore, the steps of the process 94 may be performed in the order disclosed below or in any other suitable order. In addition, in certain embodiments, one or more steps of the process 94 may be omitted, and/or the process may include one or more additional steps.

The process 94 may be utilized in embodiments in which the ground-truth sensor assembly includes the positions sensors. The process 94 includes determining two-dimensional positions of the keypoints of the object at the previous ground-truth frame from a perspective of the optical sensor, as represented by block 96. For example, the two-dimensional positions of the keypoints may be determined using a suitable computer vision technique. Furthermore, the process 94 includes matching the points within the first image with the two-dimensional positions, as represented by block 98, thereby associating the points within the first image of the set of images with the keypoints of the object at the previous ground-truth frame.

While only certain features have been illustrated and described herein, many modifications and changes will occur to those skilled in the art. It is, therefore, to be understood that the appended claims are intended to cover all such modifications and changes as fall within the true spirit of the disclosure.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function]…” or “step for [perform]ing [a function]…”, it is intended that such elements are to be interpreted under 35 U.S.C. 112(f). However, for any claims containing elements designated in any other manner, it is intended that such elements are not to be interpreted under 35 U.S.C. 112(f).

1. A tracking system for a plurality of keypoints of an object, comprising:
a controller comprising a memory and a processor, wherein the controller is configured to iteratively perform a keypoint tracking process at a first frame rate, and the keypoint tracking process comprises:
receiving a ground-truth signal from a ground-truth sensor assembly indicative of a plurality of poses of the plurality of keypoints of the object at a current ground-truth frame;
determining the plurality of poses of the plurality of keypoints of the object at the current ground-truth frame;
receiving a set of images of the object from an optical sensor at a second frame rate, wherein the second frame rate is greater than the first frame rate;
associating a plurality of points within a first image of the set of images with the plurality of keypoints of the object at a previous ground-truth frame via a calibration process;
determining the plurality of poses of the plurality of keypoints of the object at each frame of one or more intermediate frames based on the set of images via an optical flow process; and
outputting, at the second frame rate, a plurality of pose signals based on the plurality of poses of the plurality of keypoints of the object at a plurality of frames, wherein the plurality of frames comprises the previous ground-truth frame and the one or more intermediate frames.

2. The tracking system of claim 1, wherein the optical flow process comprises:
establishing a pixel patch around each point of the plurality of points, wherein the point is associated with a respective keypoint of the plurality of keypoints of the object;
tracking movement of the point between images of the set of images within the pixel patch; and
determining the pose of the respective keypoint based on the movement of the point.

3. The tracking system of claim 1, wherein the ground-truth sensor assembly comprises a second optical sensor, and the ground-truth signal is indicative of a ground-truth image of the object.

4. The tracking system of claim 3, wherein determining the plurality of poses of the plurality of keypoints of the object at the current ground-truth frame comprises determining the plurality of poses based on the ground-truth image using a convolutional neural network.

5. The tracking system of claim 3, wherein the calibration process comprises optically matching the plurality of points within the first image with the plurality of keypoints of the object at the previous ground-truth frame.

6. The tracking system of claim 1, wherein the ground-truth sensor assembly comprises a plurality of positions sensors coupled to the object.

7. The tracking system of claim 6, wherein the calibration process comprises:
determining a plurality of two-dimensional positions of the plurality of keypoints of the object at the previous ground-truth frame from a perspective of the optical sensor; and
matching the plurality of points within the first image with the plurality of two-dimensional positions.

8. A method for tracking a plurality of keypoints of an object, comprising iteratively performing steps of the method at a first frame rate, wherein the steps comprise:
receiving, via a controller comprising a processor and a memory, a ground-truth signal from a ground-truth sensor assembly indicative of a plurality of poses of the plurality of keypoints of the object at a current ground-truth frame;
determining, via the controller, the plurality of poses of the plurality of keypoints of the object at the current ground-truth frame;
receiving, via the controller, a set of images of the object from an optical sensor at a second frame rate, wherein the second frame rate is greater than the first frame rate;
associating, via the controller, a plurality of points within a first image of the set of images with the plurality of keypoints of the object at a previous ground-truth frame via a calibration process;
determining, via the controller, the plurality of poses of the plurality of keypoints of the object at each frame of one or more intermediate frames based on the set of images via an optical flow process; and
outputting, via the controller at the second frame rate, a plurality of pose signals based on the plurality of poses of the plurality of keypoints of the object at a plurality of frames, wherein the plurality of frames comprises the previous ground-truth frame and the one or more intermediate frames.

9. The method of claim 8, wherein the optical flow process comprises:
establishing, via the controller, a pixel patch around each point of the plurality of points, wherein the point is associated with a respective keypoint of the plurality of keypoints of the object;
tracking, via the controller, movement of the point between images of the set of images within the pixel patch; and
determining, via the controller, the pose of the respective keypoint based on the movement of the point.

10. The method of claim 8, wherein the ground-truth sensor assembly comprises a second optical sensor, and the ground-truth signal is indicative of a ground-truth image of the object.

11. The method of claim 10, wherein determining the plurality of poses of the plurality of keypoints of the object at the current ground-truth frame comprises determining the plurality of poses based on the ground-truth image using a convolutional neural network.

12. The method of claim 10, wherein the calibration process comprises optically matching, via the controller, the plurality of points within the first image with the plurality of keypoints of the object at the previous ground-truth frame.

13. The method of claim 8, wherein the ground-truth sensor assembly comprises a plurality of positions sensors coupled to the object.

14. The method of claim 13, wherein the calibration process comprises:
determining, via the controller, a plurality of two-dimensional positions of the plurality of keypoints of the object at the previous ground-truth frame from a perspective of the optical sensor; and
matching, via the controller, the plurality of points within the first image with the plurality of two-dimensional positions.

15. A tracking system for a plurality of keypoints of an object, comprising:
a ground-truth sensor assembly configured to output a ground-truth signal indicative of a plurality of poses of the plurality of keypoints of the object;
an optical sensor configured to output images of the object; and
a controller communicatively coupled to the ground-truth sensor assembly and to the optical sensor, wherein the controller comprises a memory and a processor, and the controller is configured to iteratively perform a keypoint tracking process at a first frame rate, and the keypoint tracking process comprises:
receiving the ground-truth signal from the ground-truth sensor assembly indicative of the plurality of poses of the plurality of keypoints of the object at a current ground-truth frame;
determining the plurality of poses of the plurality of keypoints of the object at the current ground-truth frame;
receiving a set of the images of the object from the optical sensor at a second frame rate, wherein the second frame rate is greater than the first frame rate;
associating a plurality of points within a first image of the set of images with the plurality of keypoints of the object at a previous ground-truth frame via a calibration process;
determining the plurality of poses of the plurality of keypoints of the object at each frame of one or more intermediate frames based on the set of images via an optical flow process; and
outputting, at the second frame rate, a plurality of pose signals based on the plurality of poses of the plurality of keypoints of the object at a plurality of frames, wherein the plurality of frames comprises the previous ground-truth frame and the one or more intermediate frames.

16. The tracking system of claim 15, wherein the optical flow process comprises:
establishing a pixel patch around each point of the plurality of points, wherein the point is associated with a respective keypoint of the plurality of keypoints of the object;
tracking movement of the point between images of the set of images within the pixel patch; and
determining the pose of the respective keypoint based on the movement of the point.

17. The tracking system of claim 15, wherein the ground-truth sensor assembly comprises a second optical sensor, the ground-truth signal is indicative of a ground-truth image of the object, and determining the plurality of poses of the plurality of keypoints of the object at the current ground-truth frame comprises determining the plurality of poses based on the ground-truth image using a convolutional neural network.

18. The tracking system of claim 17, wherein the calibration process comprises optically matching the plurality of points within the first image with the plurality of keypoints of the object at the previous ground-truth frame.

19. The tracking system of claim 15, wherein the ground-truth sensor assembly comprises a plurality of positions sensors coupled to the object.

20. The tracking system of claim 19, wherein the calibration process comprises:
determining a plurality of two-dimensional positions of the plurality of keypoints of the object at the previous ground-truth frame from a perspective of the optical sensor; and
matching the plurality of points within the first image with the plurality of two-dimensional positions.
